(19) United States
(12) Patent Application Publication
(10) Pub. No.: US 2023/0409513 A1
(43) Pub. Date: Dec. 21, 2023

(54) DEVICE, PREFERABLY USB DEVICE, CORRESPONDING COMPUTER DEVICE AND METHOD

(71) Applicant: Christoph HELDEIS, München (DE)

(72) Inventor: Christoph HELDEIS, München (DE)

(21) Appl. No.: 18/247,830

(22) PCT Filed: Oct. 7, 2020
(86) PCT No.: PCT/EP2020/078168

§ 371 Date: Apr. 4, 2023

(51) Int. Cl. G06F 13/42; G06F 13/38

(52) U.S. Cl. CPC G06F 13/4295; G06F 2213/0042; G06F 13/385

(57) ABSTRACT

A device, preferably USB device, including at least one memory unit which is configured to store a firmware program including instructions and at least one interface unit which is configured to forward data to a main processing device according to the USB specification. At least one processor which is configured to perform the instructions of the firmware program, wherein the processor is configured to be externally triggered by trigger events to send at least one data packet including the data to be forwarded via the interface unit.

### DESCRIPTION

The disclosure relates a peripheral device of a computer system, preferably to a USB device. Some input devices, for instance mouse, trackball and keyboard, are known for decades and other input devices have been developed only recently, for instance electronic input pen (Apple (may be a trademark) pen, stylus pen) and three-dimensional mouse (for instance Spacemouse (may be a trademark)).

On one side, there are main stream applications of input devices. Exemplary, typing a text and/or navigating within a text. On the other side there are special applications of input devices, for instance in CAD (Computer Aided Design) or Gaming (E-Sport).

Time aspects are defined for instance within the USB (Universal Serial Bus) or in another standard specification, for instance a base interval between two trigger events. It is possible to transmit several data within one specified base interval. However, there is no exact timing possible within an interval.

It is an object of the invention to provide an improved device, especially an improved input device that allows the consideration of further time aspects. The device should be preferably simple and/or cost efficient and/or provide comfort to the user and/or for service in case of errors and/or of maintenance. Preferably, the device should allow exact timing also within a base interval. Furthermore, it should be preferably be possible to use device drivers of the operating system, especially without modifications. Furthermore, a corresponding method and other corresponding technical solutions shall be given.

This object is solved by the system according to claim 1. Further embodiments are given in the dependent claims. Furthermore, the object is solved by the subject matter of the independent claims.

### SUMMARY

Device, preferably USB device, comprising:
At least one memory unit which is configured to store a firmware program comprising instructions,
At least one interface unit which is configured to forward data to a main processing device according to the USB specification or to another standard,
At least one processor which is configured to perform the instructions of the firmware program,

wherein the processor is configured to be externally triggered by trigger events to send at least one data packet comprising the data to be forwarded via the interface unit.

### Embodiments

A first aspect of the disclosure relates to a device, preferably a USB device, comprising:
At least one memory unit which is configured to store a firmware program comprising instructions,
At least one interface unit which is configured to forward data to a main processing device according to the USB specification or to another standard,
At least one processor which is configured to perform the instructions of the firmware program,

wherein the processor is configured to be externally triggered by trigger events to send at least one data packet comprising the data to be forwarded via the interface unit.

The device may be or may comprise an input device for user input, especially mechanical user input:
a computer mouse,
an optical navigation element,
a trackball,
an electronic pen, pressure sensitive
a keyboard,
a touchscreen,
space mouse for CAD, e.g. for CAD power users, e.g. a three-dimensional mouse that detects movements not only within a two-dimensional plane but in the three-dimensional space. A third coordinate may be transferred in addition to two lateral coordinates, for instance a vertical distance with regard to a reference surface or reference point.

Alternatively, the device may be an output device, for instance an optical output device. The output device may also generate data which is similar to input data, for instance during maintenance. An example for an optical output device is an LED string controller device. However, the disclosure may also be used for other peripheral output devices, e.g. for a printer, a monitor, a touchscreen, a speaker and/or for a sound card.

The memory unit may comprise a programmable memory, for instance an EEPROM (Electrical Erasable Programmable Read Only Memory) or another type of non-volatile memory, for instance a Flash EEPROM or a solid-state drive (SSD).

The interface unit may be a USB device function which may be implemented in several ways as is mentioned below, e.g. integrated within an MCU (Micro Controller Unit), on a separate MCU or on a separate USB PHY (USB Physical IC) controlled for instance by an MCU.

The processor may be a CPU (Central Processing Unit), an MCU (comprising for instance memory and more peripheral units compared to a CPU. The processor may execute instructions of software.

The processor may be configured to send the data packet according to a device class definition which is specified by the USB Implementers Forum or to another standard. The processor may be configured to generate the data to be forwarded according to a pre-given time interval which is shorter than the time between two successive trigger events or to generate time data which indicates the time at which the data to be forwarded has been generated or which allows to calculate this time, wherein preferably the usage of the pre-given time interval or the usage of the time data is defined according to a custom and/or user defined extension of the device class definition.

It is possible to have exact time data also between the base interval which is specified in a standard based on the additionally time aspects which are considered in both cases, e.g. using a pre-given time interval or using time data. The pre-given time interval is less than the time interval specified in the standard and named as base interval. The pre-given time interval may not be transmitted between sender (transmitter) and receiver or in the opposite direction if it is known in both devices.

This may be named as an implicit timing scheme. However, if the pre-given time interval may be changed a corresponding communication is possible.

The transmission of time data is an explicit timing scheme which allows more flexibility and/or which creates less data.

Custom and/or user defined means that the definition is not within the standard, for instance not within the USB specification or within RS485 or within CAN (Controller Area Network). The custom and/or user defined definition has not to be agreed with other parties which reduces effort during product development. Furthermore, the custom and/or user defined extensions are not so obvious for third parties because only firmware may be involved which may not be read without additional effort by third parties.

The processor may be configured to detect the data to be forwarded at, at least two time points between two successive trigger events. The processor may be configured to generate a sequence of the data to be forwarded within the data packet. The place of the data to be forwarded within the sequence may corresponds to the place of a respective one of the at least two time points within a sequence of time points in which later time points have higher positions within the sequence compared to earlier time point. A fixed time interval may be used in order to specify the at least two time points.

Thus, an implicit timing scheme may be used based on the two sequences. Within the sequence of data to be forwarded all members or only “filled” members may be transmitted. If only “filled” members of the sequence are transmitted it is possible to transmit data which specifies the place number or the position within the sequence of data.

At least one data package may be generated from the data to be forwarded which data is implicitly mapped to time-stamps for instance according to at least two or at least three time points between two successive trigger events. A fixed time interval may be used in order to determine the points in time beginning for instance from a start time point. At least 10 time points, at least 100 time points, at least 1000 time points may be used between two successive (immediately following to each other) trigger events. Less than for instance 1 million time points may be used depending for instance on the calculation power of the used processors.

In an explicit timing scheme, the processor may be configured to determine a corresponding time data for the data to be forwarded, e.g. an interval data using a fixed reference time point or a time interval relative to the time which is relevant for a preceding time data. Alternatively, it is possible to use exact time data, e.g. hour, minute, second, millisecond, microsecond or only a part of these data in order to save memory and transmission capacity. The processor may be configured to transmit the time data via the interface unit.

The data package may be generated from data to be forwarded, for instance from user input data, which is explicitly mapped with time stamp data comprising at least one timestamp which specifies a time between two successive trigger events and wherein the time stamp data is included within the data package or within a separate data package that is also transmitted via the interface unit. Time data may be generated at least 10 times, at least 100 times, at least 1000 times between two successive trigger events according to a standard base interval. Time data for less than for instance 1 million time points may be generated within one base interval depending for instance on the calculation power of the used processors.

The device may be preferably a mouse device or a keyboard. The device may comprise at least one input element which is configured to detect haptic user input and to generate the data to be forwarded or to deliver data which is used to generate the data to be forwarded. The haptic input may be detected according to the instructions of the firmware program the device. The processor may be configured to detect/generate user input data. A mouse device may comprise a wheel or ball for detecting rotation, a movement detection device (sensor) which detects movement in at least on direction, two directions or three directions, and/or/at least one switch, for instance two buttons (left button and right button) or three buttons (plus middle button). Furthermore, the mouse may comprise a number keypad, for instance on a side face. The same may be valid for a trackball. The movement of a cursor on a display may be made smoother and more uninterrupted using the proposed mouse device.

In the case in which the device comprises a keyboard, the data to be forwarded may describe the pressing of a key of the keyboard, e.g. a keycode may be used. The keyboard may not be part of a mouse device. The keyboard may comprise alphanumeric keys, for instance more than 100 keys.

Furthermore, for both the mouse device and the keyboard the input may be made more precise. This may be an advantage in E-sport and gaming.

The device may be a device which fulfills the HID (Human Device Interface) class specification of the USB specification. Data to be forwarded may include user input data. The custom/user extension of the HID class specification may be used to define the time data in more detail, for instance type, length, place in the data packet. Optionally, report descriptors may be defined using the custom/user extension of the HID class specification.

The device may comprise a computer mouse. Furthermore, the device may comprise a motion sensor which generates the data to be forwarded depending on a position or a movement of the computer mouse. The device (especially the processor) may be configured to poll the sensor more than two, more than three, more than ten or more than 100 times between a first trigger events and an immediately successive trigger event, e.g. within a base interval defined by a standard. Additionally or alternatively, data which is polled between the first trigger event and the second trigger event may be sent, for instance completely or to at least 90 percent, in a report for the time interval which is defined by the first trigger event and the second trigger event. This may be different from known devices which transmit the polling data only in report that is valid for the next two trigger events.

The sensor may be a CCD (Charge Coupled Device) motion sensor having or comprising at least 20 pixels, for instance at least 36 pixels (x-direction) by 36 pixels (y-direction) or 30 pixels (x-direction) by 30 pixels (y-direction). Alternatively, a CMOS (Complementary Metal Oxide Semiconductor) sensor may be used for optical detection of the movement of the mouse device. A further example is a sensor which measures the movement based on interference using laser light.

Excellent performance of the mouse device may result from using the invention together with a polling sensor which may be polled 5000 times or more than 5000 times or 10000 times or more than 10000 times per second. It may be possible to prevent that the sensor sums up successive movement events, e.g. the spatial resolution of the sensor may be used completely. Alternatively, the resolution may be made higher as in prior art devices.

The input element may be an analog input element. The device may comprise at least one transforming unit which transforms an analog output signal of the input element to a digital value. The transforming unit may comprise or may be an analog digital converter (ADC), for instance an ADC having an output bit width of at least 2 bits, 4 bits, 8 bits 10 bits or more. Other transforming units are possible as well which do not comprise an ADC.

The device may be an optical output device. The optical output device may comprise at least one connection port for the electrical and/or mechanical connection to at least one LED (Light Emitting Diode) string and/or the LED string(s). The optical output device may control the operation of the LEDs of the LED string dependent on data received from a main processing device via the at least one interface or via a further interface. It may be possible to measure electrical parameters at the connection to the LED string and to visualize these parameters using a GUI as is explained in more detail below.

Thus, the data to be forwarded may be read from the optical output device. The optical output device may comprise LEDs, preferably RGB (Red, Green, Blue) LEDs, monochrome LEDs or LEDs of other colors. The LEDs may be electrically connected to form an LED-string. The data which is read may be measurement data. A GUI may be used to display the measurement data with high time resolution but with low overhead with regard to the main function of the optical output device.

The device may be a device which fulfills the CDC (Communication Device Class) class specification. The custom/user specified or defined extension of the CDC class specification may be used to define the usage of the time data in more detail. Type, length, place of data within a data packet may be defined.

Alternatively or additionally, the device may a device which fulfills the MSC (Mass Storage Class) class specification of the USB specification. The custom/user defined extension of the MSC class specification is used to define the usage of the time data in more detail. Type, length, place of data within a data packet may be defined.

Composite devices may be used, for instance in order to ease firmware loading and/or to transfer measured data from the device, for instance from a computer mouse device.

The processor may be configured to generate for data to be forwarded within the same data package at least two time data which indicate the time interval between the time points relevant for a respective pair of two successive time data to be forwarded or which indicate the time interval between a reference time point and the time point relevant for the respective one of the at least two time-interval data. The processor may be configured to transmit the at least two time-interval data via the interface. The same data packet or a different data packet may be used to transmit the time data compared to the packet which comprises the data (user input data) to be forwarded. The time data may be comprised within the same data structure or within a different data structure compared to the data structure which is defined for the data to be forwarded. The time data may be used to calculate time stamp data for forwarded date within data packets.

The processor may be configured to generate time interval data which may be included within the header of a data package which comprises several of the data to be forwarded. Preferably, a time interval specified within the time interval data may allow the calculation of a time stamp for the data to be forwarded. All data of the sequence may be included within the data package. Alternatively, only some of the data of the sequence may be transmitted, for instance by using data which indicates the position within the sequence. No further time stamp data may be transmitted within a package. Preferably only one time-interval data is transmitted per packet.

The invention relates further to a Computer device, comprising:
an USB host processor,
a main processor, and
a memory,

wherein the memory is configured to include at least one program which enables the usage of a graphical user interface, and

a) wherein the memory is configured to store a device driver for a device according to one of the claims 2 to 12, and

wherein the memory comprises at least one application program which receives the data to be forwarded and which considers the pre-given interval or the time data for processing of the data to be forwarded,

wherein for variant a) the graphical user interface enables a graphical visualization/representation of the data to be forwarded according to the pre-given time interval or according to the time data using a time axis.

In a variant b) the memory is configured to store a device driver for one of the following devices:
a computer mouse device, wherein the data to be forwarded describes a position or a movement of the computer mouse device or the pressing of a button of the computer mouse device, and/or
a keyboard, wherein the data to be forwarded describes the pressing of a key of the keyboard, and/or
an optical output device, wherein the data to be forwarded describes at least one voltage signal or current signal within the optical output device,

wherein for variant b) the graphical user interface enables a graphical visualization/representation of the data to be forwarded using a time axis and using the time interval between the trigger events as specified in the USB standard.

A device driver of the operating system may be used, e.g. Windows, IOS, Linux etc.

However, proprietary device drivers of companies which produce only peripheral devices may also be used. The application may be a gaming program. The visualization of the GUI may be similar to an oscilloscope function. However, there may be no extra probe which can be contacted freely to arbitrarily test points. Thus, the probe may be hard wired within the device, for instance hard wired to an input element or another element of USB device. The GUI function is preferably a function in addition to main function of application program.

The visualization function may be included without much overhead compared to the main function of the input device or of the output device. Nevertheless, the visualization function may have a very high time resolution because of the usage of the pre-given time interval and/or of the time data. The GUI may be implemented in a device driver program and/or within the application program.

The computer device may be configured to generate the trigger events according to the USB specification using a time interval of 1 millisecond according to USB specification 2.0 or of 125 microseconds USB specification 2.0 or according to a future USB specification which is higher than 3.0 or to another USB specification which defines a time interval less than 125 microseconds.

The computer device may comprise a threshold setting unit which allows to set at least one threshold value of the device which forwards the data to be forwarded. The threshold may be displayed and/or set within the GUI (graphical User Interface). Furthermore, the result of setting the threshold may be displayed in the GUI, preferably in real time, e.g. having delay of less than 10 ms or of less than 1 ms. Thus, it is possible to set the threshold value in real time in a sophisticated manner. The threshold may refer for instance to the detection of click of mouse button or of a keyboard key or button. The threshold setting unit may be realized using part of application program and/or of device driver. The threshold may be set manually and/or automatically.

The graphical user interface may be configured to display performance data of the device, preferably of a computer mouse device and preferably at least one of the following performance data:
the USB or other standard microframe rate,
the momentary USB or other standard microframe rate,
the maximum USB or other standard microframe rate
momentary sensor poll rate, preferably a button or an image sensor,
amount of momentary delivered valid data of sensor,
USB or other standard valid data sent,
amount of polls which are left empty.

Thus, it is possible to visualize the performance data of the device in real time, i.e.

within less than 20 milliseconds or within less than 10 ms or within less than 1 ms. This may enable to select optimized threshold values for the operation of the device.

The invention relates further to a method for operating a device according to any one of the embodiments mentioned above.

The visualization function of the graphical user interface may be used by a service person in order to detect an error of the device which forwards the data to be forwarded. Alternatively or additionally, the visualization function of the graphical user interface may be used by a service person or by a user in order to set at least one threshold value for the operation of the device which forwards the data, preferably manually and/or automatically. Enhanced usability, service and maintenance is possible thereby.

The visualization function may be an auxiliary function of the device which forwards the data to be forwarded and wherein a main function of the device which forwards the data to be forwarded is an input function of haptic data from a user or an optical output function. The visualization function may be hard wired to a circuit node of the device, for instance of an input device or an output device.

The foregoing has outlined rather broadly the features and technical advantages of embodiments of the present disclosure. Additional features and advantages of embodiments of the present disclosure will be described hereinafter. These features may be the subject-matter of dependent claims. It should be appreciated by those skilled in the art that the conception and specific embodiments disclosed may be readily utilized as a basis for modifying or designing other structures or processes for realizing concepts which have the same or similar purposes as the concepts specifically discussed herein. It should also be recognized by those skilled in the art that equivalent constructions do not depart from the spirit and scope of the disclosure, such as defined in the appended claims.

For a more complete understanding of the presently disclosed concepts and the advantages thereof, reference is now made to the following description in conjunction with the accompanying drawings. The drawings are not drawn to scale. In the drawings the following is illustrated in:

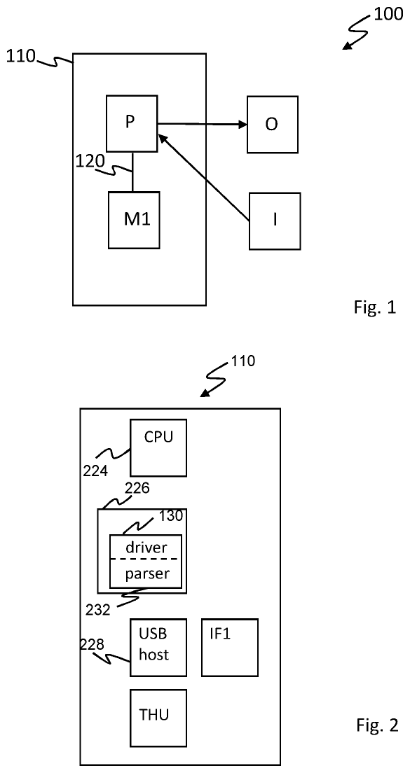

FIG. 1 a computer system that comprises an input device,

FIG. 2 a computer device of the computer system in more detail,

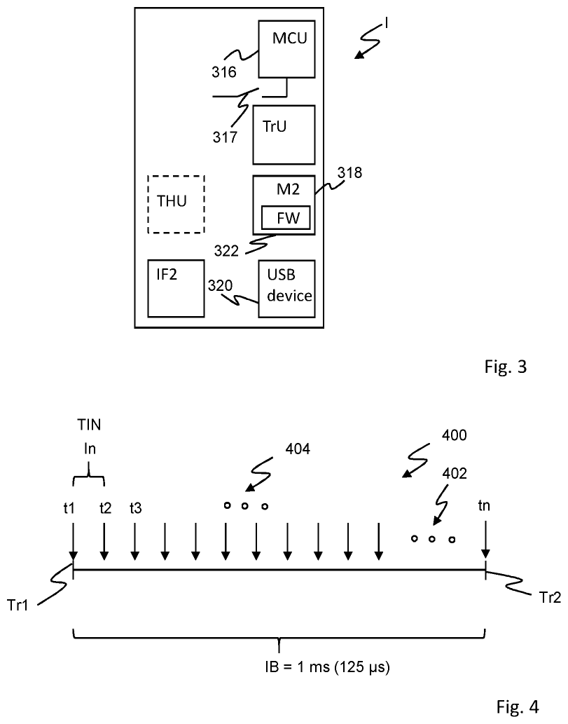

FIG. 3 the input device in more detail,

FIG. 4 a first embodiment of generating input data using a pre-given interval,

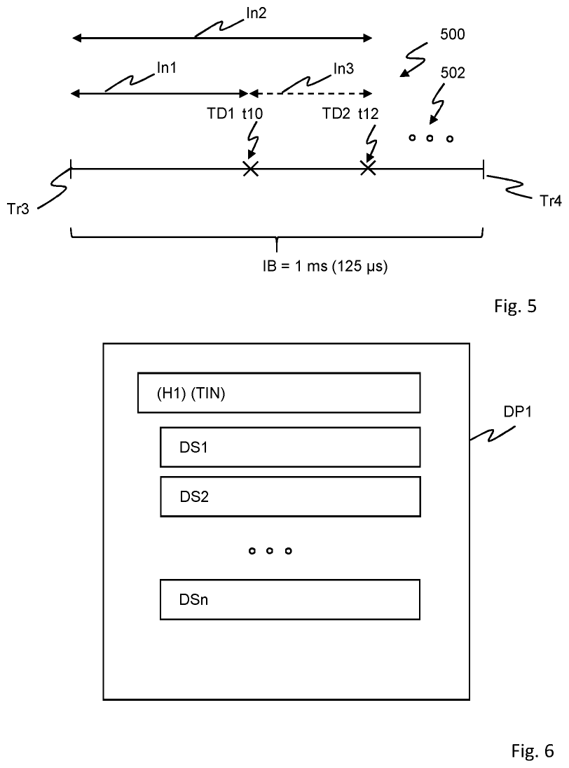

FIG. 5 a second embodiment of generating input data using time data,

FIG. 6 a data packet which comprises input data to be forwarded,

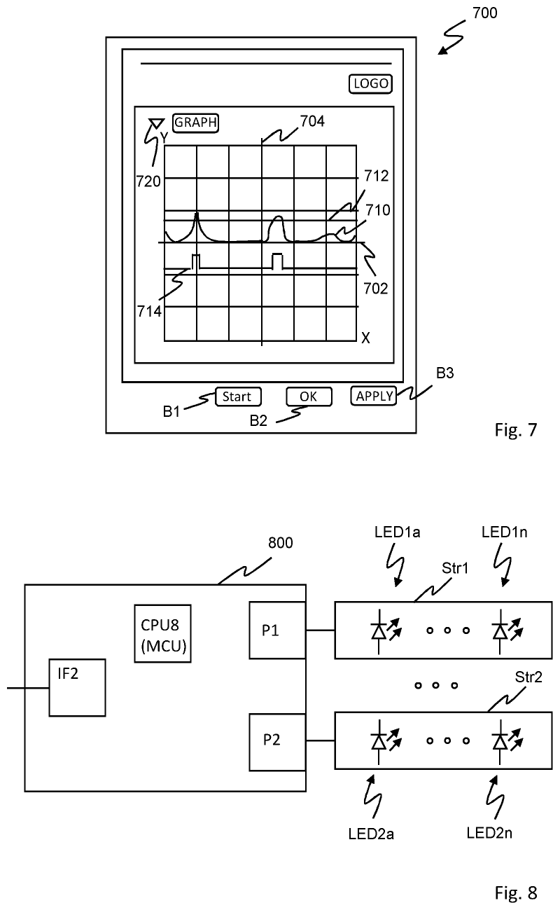

FIG. 7 a graphical user interface which is used to display the input data to a user or to a service person,

FIG. 8 an optical output device, and

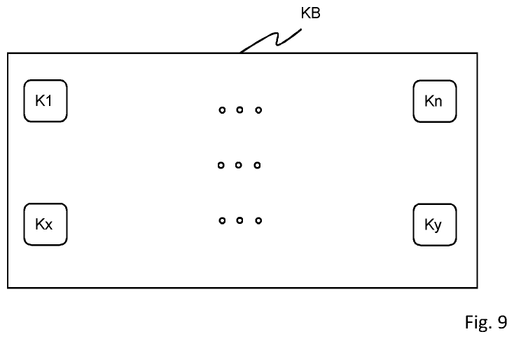

FIG. 9 a keyboard device.

FIG. 1 illustrates a computer system 100 hat comprises an input device I. Computer system 100 that may perform the method steps which are mentioned in this document. Computer system 100 may comprise:
A computer device 110, see FIG. 2 for more details.
An input device I, for instance a keyboard KB or a computer mouse device I. The input device is configured to input data that will be stored in the memory M or that is used to operate an application program, for instance a text program or a game, e.g. moving a virtual character person in the game. See FIG. 3 for more details.
An optional display device O, for instance a touchscreen device that is configured to output data that is generated during the execution of application programs.

Input device I may be:
a computer mouse, comprising for instance an electronic and/or electromechanical movement detection unit, at least two switches (e.g. micro switch, momentary contact push button switch) but usually less than 20 switches or less than 10 switches and/or a mouse wheel or mouse ball within a casing that is adapted to the hand of a user U,
a trackball device, comprising for instance a rotatable ball and several electrical input switches.
an electronic pen, comprising for instance a sending and/or receiving unit, an optional power unit and/or a pressure sensor, etc., or
a keyboard KB, comprising for instance more than 100 switches, for instance alphanumerical switches.

There may be a bus 120 between processor P and memory M. Further units of computer device 110 are not shown but are known to the person skilled in the art, for instance a power supply unit, an optional internet connection, etc. Alternatively, a server solution may be used that uses calculation power and/or memory space available on the internet supplied by other service providers or on an intranet of a company.

FIG. 2 illustrates computer device 110 of the computer system 100 in more detail.

Computer device 110 may comprise:
A processor 224, for instance a CPU (Control Processing Unit) configured to execute instructions, especially for performing the disclosed method steps.
A memory 226, M1 that is configured to store the instructions and to store data that used or generated during the execution of the instructions. Memory 226 may include non-volatile memory and/or volatile memory.
At least one computer program product stored in memory 226:
   OS (Operating System), for instance Windows (may be a trademark) or IOS (may be a trademark) or LINUX (may be a trademark), and/or
   BIOS (Basic Input Output System) may be part of the OS, and/or
   At least one or several application programs AP, and/or
   at least one or several device drivers 130, and/or
   an optional parser program 232 for implementing parts of the USB specification,
A USB host function 228, which may be integrated in the CPU, 224 or an MCU or which may be implemented on a separate MCU (Micro Controller Unit) or on an external USB PHY (USB Physical IC controlled by CPU or by an MCU),
A USB interface unit IF1 which works according to the USB specification, for instance according to USB 1.0, 2.0 or 3.0,
An optional threshold setting unit THU which allows to set the threshold value mentioned in the first part of the document. Threshold setting unit THU can be implemented either in Hardware and/or in Software, for instance in device driver 230 and/or in the application program AP. Alternatively, threshold setting unit THU may be implemented in the Firmware on the side of the peripheral device and/or in

Hardware of the peripheral device, for instance input device I.

FIG. 3 illustrates the input device I in more detail, for example a computer mouse device I. The mouse device I may comprise:
A microcontroller 316 (control unit), e.g. processor, memory and peripheral circuits, or a microprocessor or simply a processor chip,
A plurality of push buttons, see for instance push button 317, or another input element,
At least one position sensor,
A memory 318, M2, that may be part of microcontroller 316,
A USB device function 320, that may be integrated in microcontroller 316 or which may be implemented on a separate USB processor, for instance further MCU, which is controlled by MCU, 316 or which may be implemented as a separate USB PHY (USB Physical IC controlled by MCU, 316).

All input elements may comprise the same elements, for instance a push button plate in addition to push button 317. A key code may be defined and used for each push button. Push button 317 may belong to a left mouse button of input device I or of mouse device I.

Memory M2 or 318 may comprise a firmware 322, FW that includes operation instructions for the processor or controller 316. The methods mentioned in the following may be executed if the instructions of firmware 322, FW are processed by the processor or controller 316. Alternatively, a circuit without a processor and a controller 316 may be used, for instance an FPGA (Field Programmable Gate Array), PLA (Programmable Logical Array), ASIC (Application Specific Integrated Circuit), etc. A finite state machine may be realized using a processor or a device without a processor.

In more generally words, device I may be a USB device, comprising:
At least one memory unit M2 which is configured to store a firmware program FW comprising instructions,
At least one interface unit IF2 which is configured to forward data to a main processing device 110 according to the USB specification,
At least one processor MCU which is configured to perform the instructions of the firmware program FW, wherein the processor MCU is configured to be externally triggered by trigger events Tr1, TR2 to send at least one data packet DP1 comprising the data DS1 to DSn to be forwarded via the interface unit IF2.

A first embodiment relates to an implicit operation mode of considering time aspects, see description of FIG. 4 below. A second embodiment relates to an explicit operation mode of considering time aspects, see description of FIG. 5 below. For the first embodiment and for the second embodiment the following may be valid for device I:
The processor MCU is configured to send the data packet DP1 according to a device class definition which is specified by the USB Implementers Forum,
The processor MCU is configured to generate the data DS1 to DSn to be forwarded according to a pre-given time interval In which is shorter than the time IB between two successive trigger events Tr1, TR2 or to generate time data TD1, TD2 which indicates the time t10, t12 at which the data DS1 to DSn to be forwarded has been generated or which allows to calculate this time t10, t12,
The usage of the pre-given time interval In or the usage of the time data TD1, TD2 is defined according to an extension of the device class definition.

Device I may be a device which fulfills the HID and/or HID/CDC and/or the MSC class specification of the USB specification. The data DS1 to DSn to be forwarded may include user input data. An extension of the HID and/or HID/CDC and/or the MSC class specification may be used to define the structure of data DS1 to DSn and/or the structure of time data TD1, TD2 in more detail, see FIGS. 4, 5 and 6 and corresponding description.

Device I may comprise or may be a computer mouse device I. The data DS1 to DSn to be forwarded may describe a position or a movement of the computer mouse I or the pressing of a button of the computer mouse I.

Analog switches/push buttons may be used in keyboard KB. A transformation unit TrU, may be used to convert the analog values to digital values. Transformation unit TrU may comprise an ADC (Analog Digital Converter). The bit-width of the ADC may be as specified in the first part of the description, e.g. 10 bit.

FIG. 4 illustrates the first embodiment of generating input data using a pre-given interval In, see timing scheme 400. There may be less or more than the illustrated timing events at time points t1 to tn within an interval IB, see dots 402 and 404.

In more general words the following is valid for the first embodiment:
The processor MCU is configured to detect the data DS1 to DSn to be forwarded at at least two time points t1 to tn between two successive trigger events Tr1, Tr2,
The processor MCU is configured to generate a sequence of the data DS1 to DSn to be forwarded within the data packet DP1, see FIG. 6 with regard to an exemplary sequence of data.
The place of the data DS1 to DSn to be forwarded within the sequence corresponds to a respective one place of the at least two time points t1 to tn in a sequence of time points t1 to tn, and
A fixed time interval In is used in order to specify the at least two time points t1 to tn implicitly.

The time interval In may be specified by the value of time interval data TIN which may be transmitted once for each data packet DP1 or only when the length or duration of the time interval In has to be changed. Time interval In is less than the interval IB between two trigger events Tr1 and Tr2. Interval IB is 1 ms (millisecond) or 125 us (microseconds) according to the USB specification. Time interval In may be half or less than half, a third or less than a third, etc. a tenth or less than a tenth compared to the interval IB which is used at the moment for the transmission of input data which belongs to time points t1 to tn. It goes without saying that different kinds of data reduction may be used. It is for instance possible to transmit only values which are different from zero. Furthermore, it is possible to indicate the position within the sequence by additional position data.

It is possible to use at least one counter in order to determine the duration of time interval In for each sampling event. The counter may be incremented or decremented using a constant clock rate. The counter may be set to zero or to a start value again and again. Alternatively, other modes of counter setting may be used.

Exemplary, the input data may be data of a mouse wheel and/or of position (x, y (z)) or of position-change (x, y (z)) of the mouse device I or a key code of a key pressed on the mouse device I. It is for instance possible to sample the x-position or the change of the x-position as is apparent from FIG. 4.

Thus, FIG. 4 illustrates the first embodiment of generating input data using time data. An implicit timing scheme may be used with a fixed time interval In. Alternatively, time interval In may only be fixed within one or more basis intervals IB but may be changeable to other values during the operation of the input device, for instance manually and/or automatically depending for instance on input data.

FIG. 5 illustrates a second embodiment of generating input data using time data, see timing scheme 500. There may be less or more than the illustrated timing events at time points t10 to t20 within an interval IB, see dots 502.

In the second embodiment, the processor MCU is configured to determine a corresponding time data TD1, TD2 for the data DS1 to DSn to be forwarded.

Furthermore, the processor MCU is configured to transmit time data TD1, TD2 via the interface unit IF2. The description of FIG. 6 explains in more detail how the time data DS1 to DSn may be included in an exemplary sequence of data or how it may be transmitted in other ways.

An interval IB between two further successive trigger events Tr3 and Tr4 is 1 ms (millisecond) or 125 us (microseconds) according to the USB specification. Thus, all time intervals for events between trigger events Tr1 and Tr2 may be less than IB. There are the following possibilities for generating time data TD1, TD2:
To specify the time with regard to a reference value, for instance with regard to trigger event Tr3, see interval In1 for t10 (TD1) and interval In2 for t12 (TD2),
To specify the interval between successive time points t10, t12, e.g. interval In3 (TD2),
Other possibilities.

It is possible to use at least one electrical counter in order to determine the values for the duration of the time intervals. The counter may be incremented or decremented using a constant clock rate.

Exemplary, the input data may be data of a mouse wheel and/or of position (x, y (z)) or position (x, y (z)) change of the mouse device or a key code of a key pressed on the mouse. It is for instance possible that the user clicks the left mouse button at time t10.

FIG. 6 illustrates a data packet DP1 which comprises input data to be forwarded. Possible Structures (Examples but not limited to) for the input data are:

```
typedef struct
{
  union
  {
    unsigned char u8Data[8];
    struct
    {
```

| | |
|---|---|
| u8 | buttons1; (e.g. value for left mouse button) |
| u8 | buttons0; (e.g. value for right mouse button) |
| s16 | horizontal; (e.g. value for horizontal position of mouse) |
| s16 | vertical; (e.g. value for vertical position of mouse) |
| u8 | zWheel; (e.g. value giving rotation position of mouse wheel) |
| u8 | ACPan; (e.g. horizontal scan position) |

```
    };
  };
}
MOUSE_REPORT;
```

The form of the definition is for instance known from the computer language C, C#, Swift, etc. There is the following meaning of the terms:
u8: unsigned 8 bit value,
s16: signed 16 bit value, and
DATA[n]: data field comprising n values.

```
typedef struct
{
  union
  {
    unsigned char u8Data[8];
    unsigned short u16Data[4];
    unsigned short u32Data[2];
  };
}
DATA_STRUCT;
```

The data structure DATA_STRUCT may be used for the transmission of physical parameters, for instance of temperature values or other values.

```
typedef struct
{
  unsigned char mymodkey; (e.g. keycode of modifier key, e.g. Shift)
  unsigned char reserved; (e.g. for future use)
  unsigned char mykey[6]; (e.g. up to six keycodes of “normal” keys)
}
KEYBOARD_REPORT;
```

Other appropriate definitions are of course possible as well.

Data, especially input data or measurement data (for instance from an optical output device 800 as illustrated in FIG. 8), which is structured according to one of the data structures, e.g. MOUSE_REPORT, DATA_STRUCT and KEYBOARD_REPORT, may be included into data packet DP1, see data structures DS1, DS2 to DSn which form a sequence in which data DS1 is at the first position, data structure DS2 is at the second position and so on.

There may be the following possibilities to transmit time related data In, TD1, TD2 within a data package DP1 which includes also the data DS1 to DSn to be transmitted, e.g. input data:
Only within header H1, especially value of interval In in time interval data TIN,
Within each data DS1 to DSn, for instance time data TD1 in data DS1 and time data TD2 in data DS2 and so on, (definition of data structure should be adapted in this case)
Between data DS1 to DSn, for instance time data TD1 between data DS1 and data DS2, time data TD2 between data DS2 and data DS3, and so on,
After or before data structs DS1 to DSn within the same data package.

Furthermore, it is possible to transmit the time related data TD1 to TD2 or TIN in a separate data package which does not include the data DS1 to DSn to be forwarded, i.e. the input data. However, the same order may be used in the two sequences to map input data to time related data.

A further possibility is to consider the time implicitly and to not to transmit time related data at all, see for instance FIG. 4. Especially, no time related data may be transmitted which is specific for only one data packet DP1. However, alternatively it is possible to adapt also the implicit mode by transmitting different time related data (different values of time related data) which is valid for several data packages.

Time related data may be transmitted in header H1, see for instance time interval data TIN. The header may be valid for all data included within one data packet DP1.

Thus, there is a first possibility (see also FIG. 5) for transmitting time related data:
The processor MCU is configured to generate for data DS1 to DSn to be forwarded within the same data package DP1 at least two time data TD1, TD2 which indicate the time interval In3 between the time points t10, t12 relevant for a respective pair of two successive time data TD1, TD2 to be forwarded or which indicate the time interval In1, In2 between a reference time point TR1 and the time point t10, t12 relevant for the respective one of the at least two time data TD1, TD2,
The processor MCU is configured to transmit the at least two time-interval data TD1, TD2 via the interface IF2, preferably within the same data package or within a further data package.

A second possibility (see also FIG. 4) for transmitting time related data is as follows:
The processor MCU is configured to generate time interval data TIN which is included within the header H1 of a data package DP1 which comprises several of the data DS1, DS2 to be forwarded,
A time interval In specified within the time interval data TIN allows the calculation of a time stamp for the data DS1 to DSn to be forwarded.

A third possibility is the implicit consideration of further time aspects as mentioned above.

FIG. 7 illustrates a graphical user interface 700 which is used to display the input data DS1 to DSn to a user or to a service person. Graphical user interface 700 is optional for the first embodiment as well as for the second embodiment.

The following is valid for the graphical user interface 700 if used in the first embodiment (FIG. 4) or in the second embodiment (FIG. 5). Computer device 110 may comprise:
USB host function 228,
Main processor 224, and
Memory 226,
Memory 226 is configured to include at least one program which enables the usage of a graphical user interface 700,
Memory 226 and/or main processor 224 is configured to store device driver 230 for the device I,
Memory 226 comprises at least one application program which receives the data DS1 to DSn to be forwarded and which considers the pre-given interval In or the time data TD1, TD2 for processing of the data DS1 to DSn to be forwarded,
Graphical user interface 700 enables a graphical visualization of the data DS1 to DSn to be forwarded according to the pre-given time interval In or according to the time data TD1, TD2 using a time axis X.

A third embodiment relates to the usage of the graphical user interface 700 without extending the USB specification and/or an USB device class specification, e.g. HID, CDC, MSC, with regard to the consideration of additional time aspects. The following may be valid for the third embodiment.

Computer device 110 may comprise:
USB host function 228,
Main processor 224,
Memory 226,
Memory 226 is configured to include at least one program which enables the usage of graphical user interface 700,
Memory 226 is configured to store device driver 230 for one of the following devices:
   A computer mouse device I, see FIG. 3, wherein the data DS1 to DSn to be forwarded describes a position or a movement of the computer mouse device I or the pressing of a button of the computer mouse device I, and/or
   A keyboard KB, see FIG. 9, wherein the data DS1 to DSn to be forwarded describes the pressing of a key K1 to Km of the keyboard KB, and/or
   An optical output device 800, see FIG. 8, wherein the data DS1 to DSn to be forwarded describes at least one voltage signal or current signal within the optical output device 800,
Graphical user interface 700 enables a graphical visualization of the data DS1 to DSn to be forwarded using a time axis X and using the time interval IB between the trigger events Tr1, Tr2 as specified in the USB standard.

In more detail the following may be valid for all three embodiments of the graphical user interface 700. Graphical user interface 700 may comprise:
A coordinate system comprising a horizontal x-axis 702 (time) and a vertical y-axis 704 (data value),
several buttons:
   button B1 (start of graphical representation/visualization), and/or
   button B (end of measurement, close window or App), and/or
   button B3 (apply new configuration to incoming values).
A submenu 720 allowing to adjust further settings, for instance to set a threshold value for the device I, KB or 800 and to change the kind of representation of the data, for instance in addition to or alternatively to the graph 710 a table of values of input and/or measurement data including values of time data.

FIG. 7 illustrates exemplary a graph 710 visualizing the data DS1 to DSn which have been transmitted according to the first embodiment, the second embodiment or to the third embodiment. Further, optional graphs 712 (indicating for instance the value of an adaptable threshold value which may be adapted using the GUI 700), 714 (indicating a resulting signal if the threshold value (graph 712) is used for the analysis or evaluation of graph 710 which represents the data DS1 to DSn) may be displayed together with graph 710. Graph 714 may represent a resulting digital signal having high and low signal value. Exemplary, graph 714 may represent whether a mouse button is detected as being pressed or not. The same may be valid for instance for the analog signal of a button of a keyboard or of another input device.

Furthermore and optionally, the graphical user interface 700 may be configured to display performance data of the device. The following data may be displayed for a computer mouse device (I) or for other devices. At least one, at least two, at least three, at least four or all of the following performance data may be displayed for instance:
the USB or other standard microframe rate,
the momentary USB or other standard microframe rate,
the maximum USB or other standard microframe rate
momentary sensor poll rate, preferably a button or an image sensor,
amount of momentary delivered valid data of sensor,
USB or other standard valid data sent,
amount of polls which are left empty.

This may enable advanced maintenance and/or advanced setting of at least one threshold value. The following is an example for a table which may be displayed in GUI 700:

| Event | Current/momentary value |
|---|---|
| USB Polls | 1000/8K |
| Sensor Polls | 10000 |
| Sensor Valid Data Read | 4000 |
| USB Valid Data Send | 4000 |
| USB Empty Data Send | 0/1000 |

The sensor may be a motion sensor which delivers values for the x-motion and/or for the y-motion of the mouse. The sensor may be able to output a sum of values of motion data. However, is polling is fast enough summing up of values may not be necessary any more. A polling rate of 10000 per second is only an example. Other polling rates may be possible as well, for instance within the range of 5000 to 30000 times per second.

FIG. 8 illustrates an optical output device 800. Optical output device 800 may comprise at least one connection port P1, P2 for the electrical and/or mechanical connection of the optical output device 800 to at least one LED (Light Emitting diode, or alternatively other optical output element(s)) string Str1, Str2. Only one LED string, e.g. Str1 is possible as well. Alternatively, more than two LED strings Str1, Str2 may be controlled by optical output device 800, for instance within the range of 1 to 6 including 1 and 6 or within a range of 1 to 24 including 1 and 24 or even more strings. Alternatively and/or additionally, the optical output device 800 may comprises at least one LED string Str1, Str2, Str-n.

Optical output device 800 may comprise a control unit CPU8 which controls the operation of LEDs LED1a to LED2n (n is a natural number, for instance within the range of 1 to 10000 or within the range of 1 to 1000 or within the range of 1 to 100) of the at least one LED string Str1, Str2 dependent on data received from a main processing device, for instance computer device 110, via an interface IF3.

LED strings Str1, Str2, Str-n (n is a natural number, for instance 6 or more, or more than 24) may use WS281x, for instance WS2812 or other programmable LEDs that have integrated own capabilities in the strip. This is also known as addressable RGB (Red Green Blue) Strips.

LED strings Str1, Str2 including a serial connection of LEDs may be used for instance in order to lighten the keys of a keyboard KB, see for instance WO 2014/131699 A1, especially second aspect. Further examples of LED strings Str1, Str2 are known from WO 2020/147930 A1. Both documents are included by reference herewith for all purposes, especially for all legal purposes.

It is possible to use graphical user interface (GUI) 700 in order to display the signal at the beginning of the strip, for instance a current signal, a voltage signal, a resistance signal etc. The measurement data may be transmitted using time aspects mentioned above for the first embodiment (FIG. 4) or for the second embodiment (FIG. 5) or for the third embodiment, i.e. using the basis interval IB of the USB specification without an extension.

The optical device 800 may fulfill the HID and/or HID/CDC and/or MSC specification or another USB device class specification which may be extended or not, especially with regard to the transmission of the measurement data. An extension of the HID and/or HID/CDC and/or MSC class specification may be used to define the structure of data DS1 to DSn and/or the structure of time data TD1, TD2 in more detail.

FIG. 9 illustrates a keyboard device KB. Keyboard KB may comprise the same units as input device I, i.e. MCU, memory, USB device function, see FIG. 3 and corresponding description. Further, keyboard KB comprises man keys K1 to Ky. Keyboard device KB may fulfill the HID and/or HID/CDC and/or MSC class specification of the USB specification. Data DS1 to DSn to be forwarded may include user input data, especially key codes of pressed keys. The custom and/or user defined extension of the HID and/or HID/CDC and/or MSC class specification may be used to define the structure of the data DS1 to DSn and/or as the structure of time data TD1, TD2 in more detail.

Thus, the data to be forwarded describes the pressing of a key K1 to Ky of keyboard KB. Keyboard KB, especially an alpha numeric keyboard, may have at least 50 key switches, usually not more than 200 key switches or not more than 2000 key switches/push buttons. Keyboard KB may be a device separate from computer device 110 or it may be an integral part of computer device 110. Alternatively, keyboard KB may have less switches/push buttons. A keypad may have between 10 and 20 key switches, especially a keypad used for entrance control.

For instance, keyboard KB may comprise of at least one, two, three, four, five or all of:
at least 25 keys for the input of letters a, b, c etc.,
at least 10 keys for the input of digits 0, 1, 2, etc., preferably combined with further input characters, for instance “!”, “§”, “$” etc.
at least 10 keys for functions, i.e. function F1, function F2, etc.,
at least 10 keys of a keypad for entering numbers, i.e. digits 0, 1, 2, etc., especially a further group of these numbers,
no further input characters are used for the keys of the further group,
modifier keys as for instance defined in the HID (Human Interface Device) specification, i.e. left CTRL, left SHIFT, left ALT, left GUI (Graphic User Interface), i.e. for instance Microsoft left Win key, Macintosh Left Apple key, Sun left Meta key etc., right CTRL, right SHIFT, right ALT, right GUI, -auxiliary keys: Caps Lock, Tab, Spacebar, Page Down, Page Up, Right Arrow, Left Arrow, Up Arrow, Down Arrow.

Alternatively, a keypad, a game console, a game pad or a computer mouse that has a lot of buttons, for instance more than 10 buttons may be used in the same way as keyboard KB.

Data transfer of input data from keyboard KB to main computer device 110 may be realized according to the first embodiment (FIG. 4) or according to the second embodiment (FIG. 5), i.e. extension of the USB specification, especially of a USB device class specification. Again, usage of the graphical user interface 700 is optional for the first embodiment or the second embodiment of keyboard KB.

The third embodiment may be valid for keyboard KB as well, i.e. using graphical user interface 700 with timing aspects only as defined in the USB specification, i.e. using the basis interval IB of the USB specification without an extension.

Analog switches/push buttons may be used in keyboard KB. Transformation unit TrU, see FIG. 3 may be used to convert the analog values to digital values.

In other words, USB full speed FS micro frame (polling) is defined to be once every 1 millisecond for 12 Mbit/s (Megabit per second) bandwidth. USB high speed HS micro frame (polling) is defined to be once every 125 microseconds for a bandwidth of 480 Mbit/s or 60 MB/s (Megabyte per second)

Thus, full speed FS has a limitation to 1 kHz (Kilohertz). The invention is based for instance on the following idea: If the delay of 1 ms (millisecond) is accepted and if more data is transferred within the basic interval IB considering further time aspects then it is possible to break the limitation, i.e. there may be a higher time resolution within the data packet DP1 or within a series of data packets DP1 which are transferred each millisecond. If for example the time interval of 1 ms is separated or divided into 10 segments or sub-intervals then it is possible to have a time period of 100 microseconds between two subsequent data values corresponding to 10 kHz. Factor 100 gives 100 kHz and factor 1000 for dividing gives 1 MHz and so on. This may enable a very high time-resolution of input values.

The same idea holds for high speed HS USB where chips are more expensive compared to chips for full speed FS USB. High speed HS has a specified limitation to 8 kHz (Kilohertz). If the delay of 125 microseconds is accepted and if more data is transferred within the basic interval IB considering further time aspects then it is possible to break the limitation, i.e. there may be a higher time-resolution within the packet DP1 or within the packets DP1 of a series of data packets which are transferred each millisecond. If for example the time interval of 1 microsecond is separated or divided into 10 segments or sub-intervals then it is possible to have a time period of 12.5 microseconds between two subsequent data values corresponding to 80 kHz. Factor 100 gives 800 kHz and factor 1000 for dividing gives 8 MHz and so on. This may enable extremely high time-resolution of input values.

This idea is for instance especially interesting for computer mouse devices I. Especially for high end devices which are used for instance by gamers or users of other E-sports (electronic sports). Furthermore, this may be relevant for keyboard KB, touchscreens, electronic pen devices, etc.

It is possible to mitigate the delay of 1 ms or of 125 microseconds if for instance analog technique is used for detection of movements of an input device I, KB, for detection whether a button 317, K1 is pressed, etc. Analog technique may allow shorter times for the detection of input events compared to mainly digital approaches. It is for instance possible to detect a signal in analog technique within 200 microseconds compared to a detection based on digital technique in 10 ms to 20 ms. Analog switches may be used for instance which have an analog output signal which indicates how “deep” the switch is pressed. The analog output signal may comprise more than two values, for instance at least three values, at least four values at least eight values and so on, especially if the analog signal is converted to a digital signal for further processing using for instance an analog digital converter ADC or another device.

The transmitted data DS1 to DSn which has a high time resolution may be used for at least one of the following purposes or for multi-purposes, for instance:
processing the data in order to detect events with a fine resolution in time, for instance the time point at which a button of a mouse or a keyboard was pressed by a gamer, an/or
for detecting the exact movement of an input device used by user, especially also detecting micro movements, and/or
displaying the data to a user or to a service person who may use the data in order to analyze where an error comes from and/or for adjusting control parameters and/or threshold values of the input device.

A special protocol may be used to represent single data values, for instance a serial protocol. Bit values may be encoded using for instance ASCII (American Standard Code for Information Interchange) code or other codes, e.g. Huffman Code etc. The protocol may be a proprietary protocol of a company or may be a standard protocol which was agreed to by at least two companies.

Timing information may be encoded implicitly by a fixed timing to save transmission capacity and memory space for storing the data. Alternatively, timing data may be transmitted in data pairs or separately for data value blocks within one data package DP1.

Movement data of a mouse input device I may be transmitted for instance. It may be a non-preferred approach to transmit the x-movement values and the y-movement value for two subsequent micro frames A and B. For micro frame A two “old” values may be transmitted and for micro frame B two “sum values” may be transmitted for the x-movement and the y-movement which has took place in the meantime, i.e. between the transmission for micro frame A and for micro frame B. However, this can result in a comparably coarse detection precision. If it is assumed that the mouse is moved 10 pixels in x-direction and 15 pixels opposite to the x-direction the result of summing up the pixels is −5 pixels. Contrary, using the new approach each movement, especially a movement by each pixel may be detected and the corresponding event may be stored and/or transmitted exactly, i.e. first pixel in x-direction, second pixel in x-direction etc. until tenth pixel in x-direction, first pixel opposite the x-direction, second pixel opposite to the x-direction and so on until the 15th pixel opposite to the x-direction.

The transmitted values are received for the corresponding time frames and a program may calculate the correct time stamps if an implicit timing scheme is used. If timing data is transmitted explicitly, the program may use the exact timing data for further processing of the data values which are also transmitted.

The idea may be used together with the well-known USB (Universal Serial Bus) protocol, i.e. USB 1.0, 2.0 (Apr. 27, 2000, Revision 2.0), 3.0 or higher developed by the companies Compaq, Hewlett-Packard, Intel, Lucent, Microsoft, NEC and Philips. This USB protocol is widely used in the computer industry, in the smartphone industry and in other industries.

Furthermore, the idea may be used together with USB Device Class Definition(s), for instance:
with Device Class Definition for Human Interface Devices (HID), Firmware specification May 27, 2001, Version 1.1, USB Implementer's Forum,
with Universal Serial Bus Class Definitions for Communication Devices (CDC) 1.2, for instance Revision 1.2 (Errata 1), Nov. 3, 2010, USB Implementer's Forum, and/or
with Universal Serial Bus Mass Storage Class (MSC) Specification overview, Revision 1.3, Sep. 5, 2008, USB Implementer's Forum and the corresponding documents:

USB Mass Storage Class Control/Bulk/Interrupt (CBI) Transport,

USB Mass Storage Class Bulk-Only (BBB) Transport,

USB Mass Storage Class UFI Command Specification,

USB Mass Storage Class Bootability Specification,

USB Mass Storage Class Compliance Test Specification,

USB Lockable Storage Devices Feature Specification (LSD FS).

However, HID may not only be relevant for USB but also for other protocols, for instance for the Bluetooth protocol of the Bluetooth Special Interest Group (SIG). Appropriate and/or corresponding changes similar to the changes mentioned above may also be made for Bluetooth or other protocols,

The invention may be use in all cases in which a time slot is defined in a standard and in which exact timing should also be used for data which is transmitted within a basic time slot. Examples for such standards are:
RS-485 (EIA-485, Electronic Industries Alliance),
CAN (Controller Area Network) which is widely used in automotive applications,
etc.

CAN is specified in ISO (International Standardization Organization) 11898-1 to ISO 11898-6 and in SAE (Society of Automotive Engineers) J2284- J2284-5.

Although embodiments of the present disclosure and their advantages have been described in detail, it should be understood that various changes, substitutions and alterations can be made therein without departing from the spirit and scope of the disclosure as defined by the appended claims. For example, it will be readily understood by those skilled in the art that many of the features, functions, processes and methods described herein may be varied while remaining within the scope of the present disclosure. Moreover, the scope of the present application is not intended to be limited to the particular embodiments of the system, process, manufacture, method or steps described in the present disclosure. As one of ordinary skill in the art will readily appreciate from the disclosure of the present disclosure, systems, processes, manufacture, methods or steps presently existing or to be developed later that perform substantially the same function or achieve substantially the same result as the corresponding embodiments described herein may be utilized according to the present disclosure. Accordingly, the appended claims are intended to include within their scope such systems, processes, methods or steps. The embodiments mentioned in the first part of the description may be combined with each other. The embodiments of the description of Figures may also be combined with each other. Further, it is possible to combine embodiments mentioned in the first part of the description with examples of the second part of the description which relates to FIGS. 1 to 9.

1. A device comprising:
a memory unit which is configured to store a firmware program comprising instructions;
an interface unit which is configured to forward data to a main processing device according to a USB specification or to another standard, a processor which is configured to perform the instructions of the firmware program;
wherein the processor is configured to be externally triggered by trigger events to send a data packet comprising the data to be forwarded via the interface unit.

2. The device according to claim 1, wherein the processor is configured to send the data packet according to a device class definition which is specified by a USB Implementers Forum or according to the other standard;
wherein the processor is configured to generate the data to be forwarded according to a pre-given time interval which is shorter than the time between two successive trigger events or to generate time data which indicates the time at which the data to be forwarded has been generated or which allows to calculate this time; and
wherein the usage of the pre-given time interval or the usage of the time data is defined according to a custom and/or user defined extension of the device class definition.

3. The device according to claim 2, wherein the processor is configured to detect the data to be forwarded at at least two time points between two successive trigger events;
wherein the processor is configured to generate a sequence of the data to be forwarded within the data packet;
wherein the place of the data to be forwarded within the sequence corresponds to a respective one of the at least two time points; and
wherein a fixed time interval is used in order to specify the at least two time points.

4. The device according to claim 2, wherein the processor is configured to determine a corresponding time data for the data to be forwarded; and
wherein the processor is configured to transmit the time data via the interface unit.

5. The device according to claim 1, wherein the device is a mouse device or a keyboard and wherein the device comprises an input element which is configured to detect haptic user input and to generate the data to be forwarded or to deliver data which is used to generate the data to be forwarded.

6. The device according to claim 5, wherein the device is a device which fulfills an HID class specification of the USB specification, wherein the data to be forwarded includes user input data; and
wherein an extension of the HID class specification is used to define the time data in more detail.

7. The device according to claim 5, wherein the device comprises a computer mouse;
wherein the device comprises a motion sensor which generates the data to be forwarded depending on a position or a movement of the computer mouse;
wherein the device is configured to poll the motion sensor more than two times between a first trigger events and an immediately successive trigger event; and/or
wherein the data which is polled between the first trigger event and the second trigger event is sent in a report for a time interval which is defined by the first trigger event and the second trigger event.

8. The device according to claim 5, wherein the input element is an analog input element; and
wherein the device comprises a transforming unit which transforms an analog output signal of the input device to a digital value.

9. The device according to claim 2, wherein the device is an optical output device;
wherein the optical output device comprises a connection port for an electrical and/or mechanical connection to an LED string and/or wherein the optical output device comprises the LED string; and
wherein the optical output device comprises a control unit which controls the operation of LEDs of the LED string dependent on data received from a main processing device via the interface or via a further interface.

10. The device according to claim 2, wherein the device fulfills a CDC class specification;
wherein an extension of the CDC class specification is used to define usage of the time data in more detail; or
wherein alternatively the device fulfills an MSC class specification of the USB specification; and
wherein an extension of the MSC class specification is used to define usage of the time data in more detail.

11. according to claim 2, wherein the processor is configured to generate for data to be forwarded within the same data package at least two time data which indicate the time interval between time points relevant for a respective pair of two successive time data to be forwarded or which indicate the time interval between a reference time point and one of the time points relevant for the respective one of the at least two time data; and
wherein the processor is configured to transmit the at least two time data via the interface unit.

12. The device according to claim 2, wherein the processor is configured to generate time interval data which is included within a header of the data package which comprises several of the data to be forwarded; and
wherein a time interval specified within the time interval data allows the calculation of a time stamp for the data to be forwarded.

13. A computer device, comprising:
a USB host processor;
a main processor; and
a memory; and
wherein the memory is configured to include at least one program which enables usage of a graphical user interface; and
a) wherein the memory is configured to store a device driver for a device comprising:
a memory unit which is configured to store a firmware program comprising instructions;
an interface unit which is configured to forward data to a main processing device according to a USB specification or to another standard, a processor which is configured to perform the instructions of the firmware program;
wherein the processor is configured to be externally triggered by trigger events to send a data packet comprising the data to be forwarded via the interface unit;
wherein the processor is configured to send the data packet according to a device class definition which is specified by a USB Implementers Forum or according to the other standard;
wherein the processor is configured to generate the data to be forwarded according to a pre-given time interval which is shorter than the time between two successive trigger events or to generate time data which indicates the time at which the data to be forwarded has been generated or which allows to calculate this time; and
wherein the usage of the pre-given time interval or the usage of the time data is defined according to a custom and/or user defined extension of the device class definition; and
wherein the memory comprises at least one application program which receives the data to be forwarded and which considers the pre-given interval or the time data for processing of the data to be forwarded;
wherein for variant a) the graphical user interface enables a graphical visualization of the data to be forwarded according to the pre-given time interval or according to the time data using a time axis; or
b) wherein the memory is configured to store a device driver for one of the following devices:
a computer mouse device, wherein data to be forwarded describes a position or a movement of the computer mouse device or pressing of a button of the computer mouse device; and/or
a keyboard, wherein the data to be forwarded describes pressing of a key of the keyboard; and/or
an optical output device wherein the data to be forwarded describes at least one voltage signal or current signal within the optical output device;
wherein for variant b) the graphical user interface enables a graphical visualization of the data to be forwarded using a time axis and using a time interval between trigger events as specified in a USB standard.

14. The computer according to claim 13, wherein the computer device is configured to generate the trigger events according to the USB specification using a time interval of at least 1 millisecond according to USB specification 2.0 or according to a future USB specification which is higher than 3.0 or to another USB specification which defines a time interval less than 125 microseconds.

15. The computer device according to claim 13, comprising a threshold setting unit which allows to set at least one threshold value of the device which forwards the data to be forwarded, wherein the graphical user interface is configured to visualize and/or to set the threshold value.

16. The computer device according to claim 13, wherein the graphical user interface is configured to display at least one of the following performance data:
a USB or other standard microframe rate,
a momentary USB or other standard microframe rate,
a maximum USB or other standard microframe rate
a momentary sensor poll rate,
a button or an image sensor,
an amount of momentary delivered valid data of sensor,
USB or other standard valid data sent, and
an amount of polls which are left empty.

17. (canceled)

18. A method of operating a computer device, wherein the computer device comprises:
a USB host processor;
a main processor; and
a memory; and
wherein the memory is configured to include at least one program which enables usage of a graphical user interface; and
a) wherein the memory is configured to store a device driver for a device comprising:
a memory unit which is configured to store a firmware program comprising instructions;
an interface unit which is configured to forward data to a main processing device according to a USB specification or to another standard, a processor which is configured to perform the instructions of the firmware program;
wherein the processor is configured to be externally triggered by trigger events to send a data packet comprising the data to be forwarded via the interface unit;
wherein the processor is configured to send the data packet according to a device class definition which is specified by a USB Implementers Forum or according to the other standard;
wherein the processor is configured to generate the data to be forwarded according to a pre-given time interval which is shorter than the time between two successive trigger events or to generate time data which indicates the time at which the data to be forwarded has been generated or which allows to calculate this time; and
wherein the usage of the pre-given time interval or the usage of the time data is defined according to a custom and/or user defined extension of the device class definition; and
wherein the memory comprises at least one application program which receives the data to be forwarded and which considers the pre-given interval or the time data for processing of the data to be forwarded;
wherein for variant a) the graphical user interface enables a graphical visualization of the data to be forwarded according to the pre-given time interval or according to the time data using a time axis; or
b) wherein the memory is configured to store a device driver for one of the following devices:
a computer mouse device, wherein data to be forwarded describes a position or a movement of the computer mouse device or pressing of a button of the computer mouse device; and/or
a keyboard, wherein the data to be forwarded describes pressing of a key of the keyboard; and/or
an optical output device, wherein the data to be forwarded describes at least one voltage signal or current signal within the optical output device;
wherein for variant b) the graphical user interface enables a graphical visualization of the data to be forwarded using a time axis and using a time interval-between trigger events as specified in a USB standard;
the method comprising:
using a visualization function of the graphical user interface in order to detect an error of the device which forwards the data to be forwarded; and/or
using the visualization function of the graphical user interface in order to set at least one threshold value for operation of the device which forwards the data.

19. The method according to claim 18, wherein the visualization function is an auxiliary function of the device which forwards the data to be forwarded and wherein a main function of the device which forwards the data to be forwarded is an input function of haptic data from a user or an optical output function.
